(19) United States
(12) Patent Application Publication
(10) Pub. No.: US 2024/0421301 A1
(43) Pub. Date: Dec. 19, 2024

(54) LITHIUM IRON PHOSPHATE POSITIVE ELECTRODE ACTIVE MATERIAL, PREPARATION METHOD THEREOF, AND LITHIUM ION BATTERY

(71) Applicant: BYD COMPANY LIMITED, SHENZHEN (CN)

(72) Inventors: Xin WEN, Shenzhen (CN); Qingqing GAO, Shenzhen (CN); Sanzhi CHEN, Shenzhen (CN); Rong HAO, Shenzhen (CN)

(21) Appl. No.: 18/815,187

(22) Filed: Aug. 26, 2024

Related U.S. Application Data
(63) Continuation of application No. PCT/CN2023/077658, filed on Feb. 22, 2023.

(30) Foreign Application Priority Data
Mar. 7, 2022 (CN) 202210228577.2

(51) Int. Cl. H01M 4/58; H01M 4/02; H01M 4/36; H01M 4/62; H01M 10/0525

(52) U.S. Cl. CPC H01M 4/5825; H01M 4/366; H01M 4/625; H01M 10/0525; H01M 2004/021; H01M 2004/028

(57) ABSTRACT

A lithium iron phosphate positive electrode active material includes a first lithium iron phosphate material that meets: 0.49<0.643D¹ₘₒ+0.439A₁<2.3, and a second lithium iron phosphate material that meets: 0.41<1.07D²ₘₒ+2.44A₂−1.70D²ₘₒ×A₂<1.9. D¹ₘₒ is a particle size of first particles that have a largest volume distribution value of the first lithium iron phosphate material. D²ₘₒ is a particle size of second particles that have a largest volume distribution value of the second lithium iron phosphate material. A₁ represents a sphericity of the first lithium iron phosphate material. A₂ represents a sphericity of the second lithium iron phosphate material. 0.3≤D¹ₘₒ≤3.2, 1≤D²ₘₒ≤5, and D¹ₘₒ<D²ₘₒ.

### CROSS-REFERENCE TO RELATED APPLICATIONS

This application is a continuation application of International Patent Application No. PCT/CN2023/077658, filed on Feb. 22, 2023, which is based on and claims the priority to and benefits of Chinese Patent Application No. 202210228577.2 filed on Mar. 7, 2022. The entire content of all of the above-referenced applications is incorporated herein by reference.

### FIELD

The present disclosure relates to the field of lithium ion batteries, and particularly to a lithium iron phosphate positive electrode active material, a preparation method thereof, and a lithium ion battery.

BACKGROUND

Lithium iron phosphate material has wide use due to the good safety, low cost, environmental friendliness and other advantages. However, the lithium iron phosphate material also has defects. The maximum compaction density of the lithium iron phosphate material is low (e.g., 2.1-2.5 g/cm3), which leads to the low energy density of batteries prepared with the lithium iron phosphate material, so the demand for batteries with a long battery life cannot be met. To improve the energy density of the battery, a lithium iron phosphate material having a high compaction density has become a popular trend of development in the industry. However, for the lithium iron phosphate material having a high compaction density, when the compaction density of the lithium is increased, the electrochemical performance of the battery is often reduced.

### SUMMARY

To solve the above technical problems, the present disclosure provides a lithium iron phosphate positive electrode active material, a preparation method thereof, and a lithium ion battery. By adjusting the particle size and sphericity parameter of two lithium iron phosphate materials forming the lithium iron phosphate positive electrode active material, the positive electrode active material obtained by mixing the two materials at a ratio can have a high compaction density, and a battery prepared therewith has excellent electrochemical performance.

In a first aspect, the present disclosure provides a lithium iron phosphate positive electrode active material, which includes a first lithium iron phosphate material that meets: 0.49<0.643D¹ₘₒ+0.439A₁<2.3, and a second lithium iron phosphate material that meets: 0.41<1.07D²ₘₒ+2.44A₂−1.70D²ₘₒ×A₂<1.9. D¹ₘₒ is a particle size of first particles that have a largest volume distribution value of the first lithium iron phosphate material. D²ₘₒ is a particle size of second particles that have a largest volume distribution value of the second lithium iron phosphate material. A₁ represents a sphericity of the first lithium iron phosphate material. A₂ represents a sphericity of the second lithium iron phosphate material. 0.3≤D¹ₘₒ≤3.2, 1≤D²ₘₒ≤5, and D¹ₘₒ<D²ₘₒ.

For the positive electrode active material, the compaction density of the positive electrode active material is generally configured by the particle size and particle size distribution of the lithium iron phosphate material, and the contribution of the sphericity of the particles to the packing of the particles is rarely considered. This leads to the consequence that when the compaction density of the mixed lithium iron phosphate positive electrode material increases, the charge-discharge cycle performance and other performances of the lithium ion battery are compromised. According to the lithium iron phosphate positive electrode active material provided in the present disclosure, by configuring the range of Dₘₒ, and the range of the relevant relation formula of Dₘₒ and the sphericity A of the two constituent lithium iron phosphate materials, the positive electrode active material obtained by mixing the two lithium iron phosphate materials at a ratio can have a high packing density, and a positive electrode sheet prepared therewith has a high compaction density that can be 2.6 g/cm³ or higher, which improves the energy density of a battery prepared with the positive electrode active material. In addition, the battery prepared with the positive electrode active material has excellent electrochemical performance, and particularly, the cycle performance will not be deteriorated. The maximum compaction density of a positive electrode sheet containing the positive electrode active material can be 2.6 g/cm³ or higher, and a battery prepared therewith has excellent electrochemical performance.

In some embodiments, D¹ₘₒ meets: 0.32≤D¹ₘₒ≤2.45.

In some embodiments, D¹ₘₒ meets: 0.40≤D¹ₘₒ≤2.45.

In some embodiments, D²ₘₒ meets: 1.2≤D²ₘₒ≤5.

In some embodiments, D²ₘₒ meets: 1.25≤D²ₘₒ≤4.95.

In some embodiments, A₁ and A₂ meet: 0.55A₁<1, and 0.5≤A₂<1.

In some embodiments, A₁ meets: 0.51≤A₁≤0.95.

In some embodiments, A₂ meets: 0.51≤A₂≤0.95.

In some embodiments, the first lithium iron phosphate material meets: 0.5≤0.643D¹ₘₒ+0.439A₁≤2.29.

In some embodiments, the first lithium iron phosphate material meets: 0.6≤0.643D¹ₘₒ+0.439A₁≤2.29.

In some embodiments, the second lithium iron phosphate material meets: 0.42≤1.07D²ₘₒ+2.44A₂−1.70D²ₘₒ×A₂≤1.89.

In some embodiments, the weight ratio of the first lithium iron phosphate material and the second lithium iron phosphate material is in the range of 1:(0.25-3).

In some embodiments, the weight ratio of the first lithium iron phosphate material and the second lithium iron phosphate material is in the range of 1:(0.25-2.5).

In some embodiments, a surface of the first lithium iron phosphate material and a surface of the second lithium iron phosphate material are coated with a carbon coating layer.

According to the lithium iron phosphate positive electrode active material provided in the first aspect of the present disclosure, the positive electrode active material is formed by mixing two lithium iron phosphate materials meeting the requirements of particle size and sphericity parameters at a ratio, and has a high compaction density. A battery prepared with the positive electrode active material has good cycle performance and rate performance. The maximum compaction density of a positive electrode sheet containing the positive electrode active material can be 2.6 g/cm³ or higher, and a battery prepared therewith has excellent electrochemical performance.

In a second aspect, the present disclosure provides a method for preparing a lithium iron phosphate positive electrode active material. The method includes the following steps. A first lithium iron phosphate material and a second lithium iron phosphate material are provided. D¹ₘₒ is a particle size of first particles that have a largest volume distribution value of the first lithium iron phosphate material, and 0.3≤D¹ₘₒ≤3.2. D²ₘₒ is a particle size of second particles that have a largest volume distribution value of the second lithium iron phosphate material, where 1≤D²ₘₒ≤5, and D¹ₘₒ<D²ₘₒ. The sphericity of the first lithium iron phosphate material and the second lithium iron phosphate material are respectively A₁ and A₂. The first lithium iron phosphate material meets a relation formula below: 0.49<0.643D¹ₘₒ+0.439A₁<2.3. The second lithium iron phosphate material meets a relation formula below: 0.41<1.07D²ₘₒ+2.44A₂−1.70D²ₘₒ×A₂<1.9. The first lithium iron phosphate material and the second lithium iron phosphate material are mixed, to obtain the lithium iron phosphate positive electrode active material.

In the method for preparing a lithium iron phosphate positive electrode active material, two lithium iron phosphate materials meeting the requirements of particle size parameters are mixed at a ratio, to allow that the obtained positive electrode active material has a high compaction density, and a battery prepared with the positive electrode active material has good cycle performance and rate performance. The preparation method has a simple process, and is easy to operate, thus being suitable for use in large-scale production.

In a third aspect, the present disclosure provides a lithium ion battery. The lithium ion battery includes a positive electrode sheet. The positive electrode sheet includes a lithium iron phosphate positive electrode active material according to the first aspect of the present disclosure, or a lithium iron phosphate positive electrode active material prepared according to the method as described in the second aspect of the present disclosure.

In some embodiments, the lithium ion battery further includes a negative electrode sheet, an electrolyte solution, and a separator located between the positive electrode sheet and the negative electrode sheet.

In some embodiments, the maximum compaction density of the positive electrode sheet is greater than 2.6 g/cm³.

In some embodiments, the positive electrode sheet includes a positive electrode current collector and a positive electrode active material layer arranged/disposed on a surface of the positive electrode current collector.

In some embodiments, the positive electrode active material layer includes the lithium iron phosphate positive electrode active material, a binder, and a conductive agent.

The lithium ion battery using the positive electrode sheet has a high energy density and excellent cycle performance.

### BRIEF DESCRIPTION OF THE DRAWINGS

FIG. 1 shows a cycle performance curve of each pouch battery in Embodiments/Examples 1 to 5 and Comparative Embodiments/Examples 1 and 2 of the present disclosure.

FIG. 2 is a process flow chart of a method for preparing a lithium iron phosphate positive electrode active material according to an embodiment of the present disclosure.

### DETAILED DESCRIPTION

The present disclosure provides a lithium iron phosphate positive electrode active material, a preparation method thereof, and a lithium ion battery. By adjusting the particle size and sphericity parameters of two constituent lithium iron phosphate materials, the positive electrode active material obtained by mixing the two materials at a ratio can have a high compaction density, and a battery prepared therewith has excellent electrochemical performance.

In a first aspect, the present disclosure provides a lithium iron phosphate positive electrode active material. The lithium iron phosphate positive electrode active material is formed by mixing a first lithium iron phosphate material and a second lithium iron phosphate material. The first lithium iron phosphate material meets a relation formula below: 0.49<0.643D¹ₘₒ+0.439A₁<2.3. The second lithium iron phosphate material meets a relation formula below: 0.41<1.07D²ₘₒ+2.44A₂−1.70D²ₘₒ×A₂<1.9. The first lithium iron phosphate material includes particles having different particle sizes. A total volume of particles having a particle size D₁ is V¹, where V¹=unit particle volume×the number of the particles having the particle size D₁. Since the first lithium iron phosphate material has different particle sizes, the particles of the first lithium iron phosphate material have a volume distribution with respect to the particle sizes. D¹ₘₒ μm is a particle size of first particles that have the largest volume distribution value of the first lithium iron phosphate material, and 0.3≤D¹ₘₒ≤3.2. The second lithium iron phosphate material includes particles having different particle sizes. A total volume of particles having a particle size D₂ is V², where V²=unit particle volume×the number of the particles having the particle size D₂. Since the second lithium iron phosphate material has different particle sizes, the particles of the second lithium iron phosphate material have a volume distribution with respect to the particle sizes. D²ₘₒ μm is a particle size of second particles that have the largest volume distribution value of the second lithium iron phosphate material, 1≤D²ₘₒ≤5, and D¹ₘₒ<D²ₘₒ. A₁ and A₂ respectively represent the sphericity of the first lithium iron phosphate material and the second lithium iron phosphate material.

For the positive electrode active material, the compaction density of the positive electrode active material is generally configured by studying the particle size and particle size distribution of the lithium iron phosphate material, and the contribution of the sphericity of the particles to the packing of the particles is rarely considered. This leads to the consequence that when the compaction density of the mixed lithium iron phosphate positive electrode material increases, the charge-discharge cycle performance and others of the lithium ion battery are compromised. According to the lithium iron phosphate positive electrode active material provided in the embodiment of the present disclosure, by configuring the range of Dₘₒ, the range of the relevant relation formula of Dₘₒ, and the sphericity A of the two constituent lithium iron phosphate materials, the positive electrode active material obtained by mixing the two lithium iron phosphate materials at a ratio can have a high packing density, and a positive electrode sheet prepared therewith has a high compaction density of 2.6 g/cm³ or higher, which improves the energy density of a battery prepared with the positive electrode active material. In addition, the battery prepared with the positive electrode active material has excellent electrochemical performance, and particularly, the cycle performance will not be deteriorated. The maximum compaction density of a positive electrode sheet containing the positive electrode active material can be 2.6 g/cm³ or higher, and a battery prepared therewith has excellent electrochemical performance.

In some embodiments, 0.5≤0.643D¹ₘₒ+0.439A₁≤2.29, and 0.6≤0.643D¹ₘₒ+0.439A₁≤2.29.

In some embodiments, 0.42≤1.07D²ₘₒ+2.44A₂−1.70D²ₘₒ×A₂≤1.89.

In some embodiments, the D¹ₘₒ of the first lithium iron phosphate material and the D²ₘₒ of the second lithium iron phosphate material can be obtained from their respective laser particle size distribution diagrams. The test method can be found in GB/T 19077-2016/ISO 13320:2009 Particle size analysis-Laser diffraction methods. In some embodiments, the test instrument is a laser particle size analyzer (such as Malvern 3000).

The sphericity A₁ and A₂ can be obtained by averaging the ratio of the longest diameter to the shortest diameter of each of multiple particles (generally 400-800 particles) in the scanning electron microscopy (SEM) images of the first lithium iron phosphate material and the second lithium iron phosphate material. Particularly, A₁ is obtained by measuring the longest diameter to the shortest diameter of each particle in the SEM image of the first lithium iron phosphate material by the software Image J. The sphericity of each particle is defined as the ratio of the longest diameter to the shortest diameter of the particle. The sphericity A₁ of the first lithium iron phosphate material is an average of the sphericities of all particles of the first lithium iron phosphate material in the SEM image. As A₁ and A₂ approximate to 1, the particles of the material are closer to a spherical shape.

In some embodiments, D¹ₘₒ<D²ₘₒ. When D¹ₘₒ of the lithium iron phosphate material is small, the lithium ion diffusion path is short, and the prepared battery has good electrical performance. When D²ₘₒ of the lithium iron phosphate material is large, the compaction density of the positive electrode active material can be increased. Given a particle size Dₘₒ that is in the above range, in combination with the relation formula between the sphericity A₁ and A₂, the two lithium iron phosphate materials can form a dense packing when they are mixed uniformly at a ratio, so that the compaction density of a positive electrode sheet prepared with the positive electrode active material prepared therewith can be increased, without compromising the cycle performance of the battery.

In some embodiments, the value of D¹ₘₒ is in the range of: 0.32 μm≤D¹ₘₒ≤2.45 μm. Further, the value of D¹ₘₒ is in the range of: 0.40 μm≤D¹ₘₒ≤2.45 μm.

In some embodiments, the value of D²ₘₒ is in the range of: 1.2 μm≤D²ₘₒ≤5 μm. Further, the value of D²ₘₒ is in the range of: 1.25 μm≤D²ₘₒ≤4.95 μm.

When D¹ₘₒ and D²ₘₒ are in the above ranges and D¹ₘₒ<D²ₘₒ, the two lithium iron phosphate materials can allow the high compaction density of the positive electrode sheet and the good electrochemical performance of the battery.

In some embodiments, 0.5≤A₁<1, and 0.5≤A₂<1. When the sphericity of the two lithium iron phosphate materials is in the above range, the positive electrode sheet can have a high compaction density. Further, in some embodiments, the value of A₁ is in the range of: 0.51≤A₁≤0.95. The value of A₂ is in the range of: 0.51≤A₂≤0.95. In the present disclosure, the first lithium iron phosphate material and the second lithium iron phosphate material can be mixed at a weight ratio, then the maximum compaction density of a positive electrode sheet prepared with the lithium iron phosphate positive electrode active material is high, and the cycle performance of a battery prepared therewith is good. In some embodiments of the present disclosure, the mixing weight ratio of the first lithium iron phosphate material and the second lithium iron phosphate material is in the range of 1:(0.25-3), and further in the range of 1:(0.25-2.5), or in the range of 1:(0.4-1.5). In this case, the positive electrode active material formed by mixing the two lithium iron phosphate materials can allow the high compaction density of the electrode sheet and the good cycle performance of the battery.

In some embodiments, the first lithium iron phosphate material and the second lithium iron phosphate material may have a carbon coating layer on the surface, which can be obtained by sequentially sanding, spray drying and sintering a mixed slurry of a phosphorus source, an iron source, a lithium source and a carbon source. In the present disclosure, the preparation method of the two lithium iron phosphate materials is not limited. The presence of the carbon coating layer allows the first and the second lithium iron phosphate material to have good electrical conductivity, and less side reactions with the electrolyte solution. The positive electrode active material obtained by mixing the two has good electrical conductivity, and the cycle performance of the battery is good.

According to the lithium iron phosphate positive electrode active material provided in the first aspect of the present disclosure, the positive electrode active material is formed by mixing two lithium iron phosphate materials meeting the requirements of particle size and sphericity parameters at a ratio, and has a high compaction density. A battery prepared with the positive electrode active material has good cycle performance and rate performance. The maximum compaction density of a positive electrode sheet containing the positive electrode active material can be up to 2.6 g/cm³ or higher, and a battery prepared therewith has excellent electrochemical performance.

In a second aspect, the present disclosure provides a method for preparing a lithium iron phosphate positive electrode active material. As shown in FIG. 2, the method includes the following steps. S101: A first lithium iron phosphate material and a second lithium iron phosphate material are provided. D¹ₘₒ μm is a particle size of first particles that have the largest volume distribution value of the first lithium iron phosphate material, and 0.3≤D¹ₘₒ≤3.2. D²ₘₒ μm is a particle size of second particles that have the largest volume distribution value of the second lithium iron phosphate material, 1≤D²ₘₒ≤5, and D¹ₘₒ<D²ₘₒ. The sphericity of the first lithium iron phosphate material and the second lithium iron phosphate material are respectively A₁ and A₂, where 0.49<0.643D¹ₘₒ+0.439A₁<2.3, and 0.41<1.07D²ₘₒ+2.44A₂−1.70D²ₘₒ×A₂<1.9. S102: The first lithium iron phosphate material and the second lithium iron phosphate material are mixed, to obtain the lithium iron phosphate positive electrode active material.

In the method for preparing a lithium iron phosphate positive electrode active material, two lithium iron phosphate materials meeting the requirements of particle size parameters are mixed at a ratio, so that the obtained positive electrode active material can have a high compaction density, and a battery prepared with the positive electrode active material has good cycle performance and rate performance. The preparation method has a simple process, and is easy to operate, thus being suitable for use in large-scale production.

A positive electrode sheet is provided. The positive electrode sheet includes a lithium iron phosphate positive electrode active material according to the first aspect of the present disclosure, or a lithium iron phosphate positive electrode active material prepared according to the method as described in the second aspect of the present disclosure.

In some embodiments, the positive electrode sheet includes a positive electrode current collector and a positive electrode active material layer arranged/disposed on a surface of the positive electrode current collector. The positive electrode active material layer includes the lithium iron phosphate positive electrode active material, a binder, and a conductive agent.

In some embodiments, the maximum compaction density of the positive electrode sheet is 2.6 g/cm³ or higher. In some embodiments, the maximum compaction density is 2.65-2.8 g/cm³, and further 2.67-2.75 g/cm³. It is to be understood that the maximum compaction density of the positive electrode sheet refers to the corresponding compaction density of the electrode sheet when the active material particles in the positive electrode sheet are crushed under a certain pressure.

The positive electrode material layer can be formed by coating a positive electrode paste including the lithium iron phosphate positive electrode active material, the conductive agent, the binder, and a solvent on the positive electrode current collector. The solvent can be one or more of N-methylpyrrolidone (NMP), acetone and dimethyl acetamide (DMAC). The positive electrode current collector includes any one of an aluminum foil, a carbon-coated aluminum foil, and a perforated aluminum foil. The conductive agent includes, but is not limited to, one or more of carbon nanotubes, graphene carbon black, carbon fiber, and the like. The binder includes, but is not limited to, one or more of polyvinylidene fluoride (PVDF), polytetrafluoroethylene (PTFE), polyvinyl alcohol (PVA), styrene-butadiene rubber (SBR), polyacrylic acid (PAA), polyacrylate, polyacrylonitrile (PAN), sodium carboxymethyl cellulose (CMC), and sodium alginate.

In a third aspect, the present disclosure provides a lithium ion battery. The lithium ion battery includes a positive electrode sheet.

In some embodiments, the lithium ion battery further includes a negative electrode sheet, an electrolyte solution, and a separator located between the positive electrode sheet and the negative electrode sheet.

The lithium ion battery using the positive electrode sheet has a high energy density and excellent cycle performance.

The following descriptions are some implementations of the present disclosure. It should be noted that several improvements and modifications can be made by those of ordinary skill in the art without departing from the principle of the present disclosure, which shall fall within the protection scope of the present disclosure.

In the following, the technical solution of the present disclosure will be described in combination with embodiments.

### Example 1

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 0.46 μm, and the sphericity was 0.8. That is, D¹ₘₒ was 0.46, A₁ was 0.8, and 0.643D¹ₘₒ+0.439A₁=0.65. A second lithium iron phosphate material LFP-2 was used. When a particle size of particles of LFP-2 that have the largest volume distribution value of LFP-2, the corresponding particle size was 1.08 μm, and the sphericity was 0.7. That is, D²ₘₒ was 1.08, A₂ was 0.7, and 1.07D²ₘₒ+2.44A₂−1.70D²ₘₒ×A₂=1.58.

The LFP-1 material and the LFP-2 material were mixed at a weight ratio of 4:6. A lithium iron phosphate positive electrode active material LFP-3 was obtained.

The lithium iron phosphate positive electrode active material LFP-3 was prepared into a positive electrode sheet as follows. The lithium iron phosphate positive electrode active material LFP-3 was mixed with a conductive agent-carbon nanotubes, a binder (e.g., polyvinylidene fluoride (PVDF)), and a solvent N-methylpyrrolidone (NMP) at a weight ratio of 100:3:2:60, and mixed uniformly, to obtain a positive electrode paste. The positive electrode paste was coated on two sides of a carbon-coated aluminum foil, and dried, to obtain a two-sided positive electrode sheet having an areal density of 360 g/m². The maximum compaction density of the positive electrode sheet without particle breakage was determined. The maximum compaction density of the positive electrode sheet was 2.72 g/cm³.

Preparation of pouch lithium ion battery: A negative electrode plate was provided, which was prepared by coating a mixed paste that contains graphite: conductive agent (carbon black): binder (e.g., SBR): water at a weight ratio of 100:2:5:120 (on a copper foil, and drying. A positive electrode sheet prepared with the lithium iron phosphate positive electrode active material LFP-3 in Example 1 was used as a positive electrode. A polypropylene film was used as a separator. A solution containing 1.0 mol/L LiPF₆ in ethylene carbonate (EC): dimethyl carbonate (DMC) at a volume ratio of 1:1 was used as an electrolyte solution. After assembly, a pouch lithium ion battery was obtained.

### Example 2

A method for preparing a lithium iron phosphate positive electrode active material in Example 2 differed from Example 1 in that the LFP-1 material and the LFP-2 material were mixed at a weight ratio of 7:3.

Following the method described in Example 1, the lithium iron phosphate positive electrode active material LFP-3 obtained in Example 2 was prepared into a positive electrode sheet, and assembled into a pouch lithium ion battery. The maximum compaction density of the positive electrode sheet in Example 2 was determined to be 2.68 g/cm³.

### Example 3

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 2.41 μm (that is, D¹ₘₒ was 2.41), the sphericity A₁ was 0.7, and 0.643D¹ₘₒ+0.439A₁=1.86. A second lithium iron phosphate material LFP-2 was used. When a particle size of particles of LFP-2 that have the largest volume distribution value of LFP-2, the corresponding particle size was 4.36 μm (that is, D²ₘₒ was 4.36), the sphericity A₂ was 0.6, and 1.07D²ₘₒ+2.44A₂−1.70D²ₘₒ×A₂=1.68.

The LFP-1 material and the LFP-2 material were mixed at a weight ratio of 8:2. A lithium iron phosphate positive electrode active material LFP-3 was obtained.

Following the method described in Example 1, the lithium iron phosphate positive electrode active material LFP-3 obtained in Example 3 was prepared into a positive electrode sheet, and assembled into a pouch lithium ion battery. The maximum compaction density of the positive electrode sheet in Example 3 was determined to be 2.65 g/cm³.

### Example 4

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 0.46 μm (that is, D¹ₘₒ was 0.46), the sphericity A₁ was 0.8, and 0.643D¹ₘₒ+0.439A₁−0.65. A second lithium iron phosphate material LFP-2 was used. When a particle size of particles of LFP-2 that have the largest volume distribution value of LFP-2, the corresponding particle size was 3.45 μm (that is, D²ₘₒ was 3.45), the sphericity A₂ was 0.7, and 1.07D²ₘₒ+2.44A₂−1.70D²ₘₒ×A₂=1.29.

The LFP-1 material and the LFP-2 material were mixed at a weight ratio of 5:5. A lithium iron phosphate positive electrode active material LFP-3 was obtained.

Following the method described in Example 1, the lithium iron phosphate positive electrode active material LFP-3 obtained in Example 4 was prepared into a positive electrode sheet, and assembled into a pouch lithium ion battery. The maximum compaction density of the positive electrode sheet in Example 4 was determined to be 2.70 g/cm³.

### Example 5

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 1.32 μm (that is, D¹ₘₒ was 1.32), the sphericity A₁ was 0.7, and 0.643D¹ₘₒ+0.439A₁=1.16. A second lithium iron phosphate material LFP-2 was used. When a particle size of particles of LFP-2 that have the largest volume distribution value of LFP-2, the corresponding particle size was 2.31 μm (that is, D²ₘₒ was 2.31), the sphericity A₂ was 0.6, and 1.07D²ₘₒ+2.44A₂−1.70D²ₘₒ×A₂=1.58.

The LFP-1 material and the LFP-2 material were mixed at a weight ratio of 4:6. A lithium iron phosphate positive electrode active material LFP-3 was obtained.

Following the method described in Example 1, the lithium iron phosphate positive electrode active material LFP-3 obtained in Example 5 was prepared into a positive electrode sheet, and assembled into a pouch lithium ion battery. The maximum compaction density of the positive electrode sheet in Example 5 was determined to be 2.68 g/cm³.

### Example 6

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 3.16 μm (that is, D¹ₘₒ was 3.16), the sphericity A₁ was 0.58, and 0.643D¹ₘₒ+0.439A₁=2.29. A second lithium iron phosphate material LFP-2 was used. When a particle size of particles of LFP-2 that have the largest volume distribution value of LFP-2, the corresponding particle size was 4.94 μm (that is, D²ₘₒ was 4.94), the sphericity A₂ was 0.57, and 1.07D²ₘₒ+2.44A₂−1.70D²ₘₒ×A₂=1.89.

The LFP-1 material and the LFP-2 material were mixed at a weight ratio of 3:7. A lithium iron phosphate positive electrode active material LFP-3 was obtained.

Following the method described in Example 1, the lithium iron phosphate positive electrode active material LFP-3 obtained in Example 6 was prepared into a positive electrode sheet, and assembled into a pouch lithium ion battery. The maximum compaction density of the positive electrode sheet in Example 6 was determined to be 2.68 g/cm³.

### Example 7

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 0.32 μm (that is, D¹ₘₒ was 0.32), the sphericity A₁ was 0.9, and 0.643D¹ₘₒ+0.439A₁=0.60. A second lithium iron phosphate material LFP-2 was used. When a particle size of particles of LFP-2 that have the largest volume distribution value of LFP-2, the corresponding particle size was 3.96 μm (that is, D²ₘₒ was 3.96), the sphericity A₂ was 0.89, and 1.07D²ₘₒ+2.44A₂−1.70D²ₘₒ×A₂=0.42.

The LFP-1 material and the LFP-2 material were mixed at a weight ratio of 4:6. A lithium iron phosphate positive electrode active material LFP-3 was obtained.

Following the method described in Example 1, the lithium iron phosphate positive electrode active material LFP-3 obtained in Example 7 was prepared into a positive electrode sheet, and assembled into a pouch lithium ion battery. The maximum compaction density of the positive electrode sheet in Example 7 was determined to be 2.66 g/cm³.

To highlight the beneficial effects of the present disclosure, the following Comparative Examples 1-5 are provided.

### Comparative Example 1

A method for preparing a lithium iron phosphate positive electrode active material includes the following steps.

A first lithium iron phosphate material LFP-1 was used, where D¹ₘₒ was 3.32 μm, A₁ was 0.8, but 0.643D¹ₘₒ+0.439A₁=2.49, which fell outside the range of (0.49, 2.3) defined in the present disclosure. A second lithium iron phosphate material LFP-2 was used, where D²ₘₒ was 3.98 μm, A₂ was 0.9, but 1.07D²ₘₒ+2.44A₂−1.70D²ₘₒ×A₂=0.37, which fell outside the range of (0.41, 1.9) defined in the present disclosure.

The LFP-1 material and the LFP-2 material were mixed at a weight ratio of 1:1. A lithium iron phosphate positive electrode active material LFP-3 was obtained.

Following the method described in Example 1, the lithium iron phosphate positive electrode active material LFP-3 obtained in Comparative Example 1 was prepared into a positive electrode sheet, and assembled into a pouch lithium ion battery. The maximum compaction density of the positive electrode sheet in Comparative Example 1 was determined to be 2.65 g/cm³. Although the maximum compaction density of the positive electrode sheet in Comparative Example 1 reached 2.6 g/cm³ or higher, the charge-discharge cycle stability of the battery was poor. As shown in Table 1 below, the first-cycle discharge specific capacity and capacity retention rate after 1000 cycles of the battery with the positive electrode sheet in Comparative Example 1were lower than those in Example 1.

### Comparative Example 2

A lithium iron phosphate positive electrode material was provided, in which one lithium iron phosphate material was used as the positive electrode active material. When a particle size of particles of lithium iron phosphate material that have the largest volume distribution value of lithium iron phosphate material, the corresponding particle size was 0.88 μm, and the sphericity A was 0.9.

Following the method described in Example 1, the positive electrode material was prepared into a positive electrode sheet, and assembled into a pouch lithium ion battery. The maximum compaction density of the pouch battery was 2.53 g/cm³.

### Comparative Example 3

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 0.31 μm (that is, D¹ₘₒ was 0.31), the sphericity A₁ was 0.6, but 0.643D¹ₘₒ+0.439A₁=0.46, which fell outside the range of (0.49, 2.3) defined in the present disclosure. A second lithium iron phosphate material LFP-2 was used. When a particle size of particles of LFP-2 that have the largest volume distribution value of LFP-2, the corresponding particle size was 5.36 μm (that is, D²ₘₒ was 5.36), the sphericity A₂ was 0.55, but 1.07D²ₘₒ+2.44A₂−1.70D²ₘₒ×A₂=2.07, which fell outside the range of (0.41, 1.9) defined in the present disclosure.

The LFP-1 material and the LFP-2 material were mixed at a weight ratio of 5:5. A lithium iron phosphate positive electrode active material LFP-3 was obtained.

Following the method described in Example 1, the lithium iron phosphate positive electrode active material LFP-3 obtained in Comparative Example 3 was prepared into a positive electrode sheet, and assembled into a pouch lithium ion battery. The maximum compaction density of the positive electrode sheet in Comparative Example 3 was determined to be 2.63 g/cm³. Although the maximum compaction density of the positive electrode sheet in Comparative Example 3 reached 2.6 g/cm³ or higher, the charge-discharge cycle stability of the battery was poor. As shown in Table 1 below, the capacity retention rate after 1000 cycles of the battery with the positive electrode sheet in Comparative Example 3 was lower than that in Example 1.

### Comparative Example 4

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 0.52 μm (that is, D¹ₘₒ was 0.52), the sphericity A₁ was 0.6, and 0.643D¹ₘₒ+0.439A₁=0.60. A second lithium iron phosphate material LFP-2 was used. When a particle size of particles of LFP-2 that have the largest volume distribution value of LFP-2, the corresponding particle size was 4.23 μm (that is, D¹ₘₒ was 4.23), the sphericity A₂ was 0.9, but 1.07D²ₘₒ+2.44A₂−1.70D²ₘₒ×A₂=0.25, which fell outside the range of (0.41, 1.9) defined in the present disclosure.

The LFP-1 material and the LFP-2 material were mixed at a weight ratio of 2:8. A lithium iron phosphate positive electrode active material LFP-3 was obtained.

Following the method described in Example 1, the lithium iron phosphate positive electrode active material LFP-3 obtained in Comparative Example 4 was prepared into a positive electrode sheet, and assembled into a pouch lithium ion battery. The maximum compaction density of the positive electrode sheet in Comparative Example 4 was determined to be 2.64 g/cm³. Although the maximum compaction density of the positive electrode sheet in Comparative Example 4 reached 2.6 g/cm³ or higher, the charge-discharge cycle stability of the battery was poor. As shown in Table 1 below, the first-cycle discharge specific capacity and capacity retention rate after 1000 cycles of the battery with the positive electrode sheet in Comparative Example 4were lower than those in Example 1.

### Comparative Example 5

A method for preparing a lithium iron phosphate positive electrode active material includes the following steps.

A first lithium iron phosphate material LFP-1 was used. When a particle size of particles of LFP-1 that have the largest volume distribution value of LFP-1, the corresponding particle size was 0.34 μm (that is, D¹ₘₒ was 0.34), the sphericity A₁ was 0.8, and 0.643D¹ₘₒ+0.439A₁=0.57. A second lithium iron phosphate material LFP-2 was used. The sphericity A₂ was 0.85. When a particle size of particles of LFP-2 that have the largest volume distribution value of LFP-2, the corresponding particle size was 0.65 μm (that is, D²ₘₒ was 0.65) which fell outside range of 1-5 μm defined in the present disclosure, and 1.07D²ₘₒ+2.44A₂−1.70D²ₘₒ×A₂=1.83, which fell outside the range of (0.41, 1.9) defined in the present disclosure.

The LFP-1 material and the LFP-2 material were mixed at a weight ratio of 4:6. A lithium iron phosphate positive electrode active material LFP-3 was obtained.

Following the method described in Example 1, the lithium iron phosphate positive electrode active material LFP-3 obtained in Comparative Example 5 was prepared into a positive electrode sheet, and assembled into a pouch lithium ion battery. The maximum compaction density of the positive electrode sheet in Comparative Example 5 was determined to be 2.52 g/cm³.

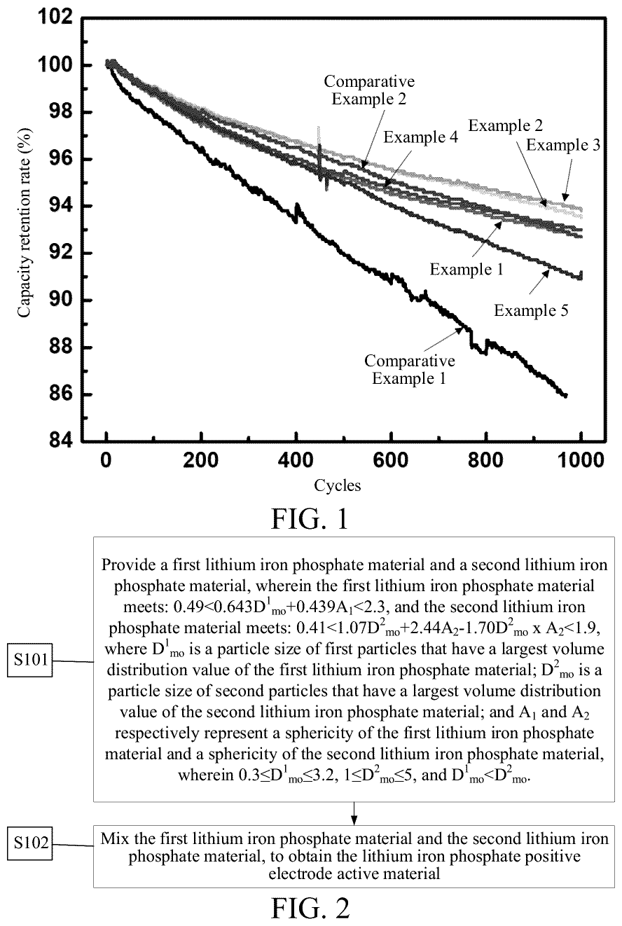

To support the beneficial effects of the embodiments of the present disclosure, the cycle performance of the pouch battery of each example and comparative example was tested. Each pouch battery was subjected to charge-discharge cycle test at 0.5 C/0.5 C at 25° C. The voltage range was 2.0-3.8 V. FIG. 1 shows a cycle performance curve of each pouch battery in Examples 1-7 and Comparative Examples 1-5. The first-cycle discharge specific capacity, the first-cycle coulombic efficiency, and the capacity retention rate after 1000 cycles of the batteries in examples and comparative examples are summarized in Table 1 below.

TABLE 1

| | First-cycle | | |
|---|---|---|---|
| | discharge | First-cycle | Capacity |
| | specific | coulombic | retention rate |
| | capacity | efficiency | after 1000 |
| Test item | (mAh/g) | (%) | cycles (%) |
| Example 1 | 141.3 | 94.5 | 92.7 |
| Example 2 | 141.5 | 94.8 | 93.5 |
| Example 3 | 140.6 | 95.1 | 93.8 |
| Example 4 | 141.2 | 94.5 | 93.0 |
| Example 5 | 140.8 | 94.3 | 91.2 |
| Example 6 | 140.7 | 93.4 | 91.6 |
| Example 7 | 141.0 | 94.6 | 92.9 |
| Comparative | 137.9 | 92.8 | 86.0 |
| Example 1 | | | |
| Comparative | 140.9 | 94.6 | 92.7 |
| Example 2 | | | |
| Comparative | 141.1 | 94.2 | 87.4 |
| Example 3 | | | |
| Comparative | 139.5 | 94.1 | 88.6 |
| Example 4 | | | |
| Comparative | 141.3 | 94.4 | 93.1 |
| Example 5 | | | |

As can be seen from FIG. 1 and Table 1, in Comparative Example 2 where one lithium iron phosphate material was used as the positive electrode active material, although the charge-discharge cycle performance of the battery is good, the maximum compaction density of the electrode sheet is low, which is not conducive to the improvement of the energy density of the battery. When two lithium iron phosphate materials are mixed by the method provided in the present disclosure, the compaction density of the positive electrode sheet prepared with the positive electrode active material is high, such as 2.6 g/cm³ or higher, even 2.68-2.75 g/cm³ in some cases. Moreover, the battery has excellent electrochemical performance, high first-cycle discharge specific capacity, and high first-cycle coulombic efficiency, and the cycle performance (e.g., of Examples 1-7) matches the cycle performance of the low-compaction-density battery in Comparative Example 2. However, when the positive electrode active material (e.g., of Comparative Examples 1, and 3-5) obtained by mixing two raw materials that do not meet the requirements in the present disclosure is used, the compaction density of the electrode sheet is too low, for example, the compaction density is less than 2.6 g/cm³ in Comparative Examples 2 and 5. Or the compaction density can reach 2.6 g/cm³ or higher in some cases, but the charge-discharge cycle stability of the battery was poor, for example, the charge-discharge cycle stability of the battery in Comparative Examples 1, 3, and 4 was poor. In general, the high compaction density of the electrode sheet and good cycle performance may not be achieved at the same time.

The foregoing embodiments show several implementations of the present disclosure and are described in detail, which, however, do not limit the scope of the present disclosure. It is to be understood that for a person of ordinary skill in the art, several variations and improvements can be made by those of ordinary skill in the art without departing from the idea of the present disclosure, which are all contemplated in the protection scope of the present disclosure. Therefore, the protection scope of the present disclosure shall be defined by the appended claims.

What is claimed is:

1. A lithium iron phosphate positive electrode active material, comprising a first lithium iron phosphate material and a second lithium iron phosphate material,
wherein the first lithium iron phosphate material meets: 0.49<0.643D¹ₘₒ+0.439A₁<2.3, and the second lithium iron phosphate material meets: 0.41<1.07D²ₘₒ+2.44A₂−1.70D²ₘₒ×A₂<1.9,
where D¹ₘₒ is a particle size of first particles that have a largest volume distribution value of the first lithium iron phosphate material; D²ₘₒ is a particle size of second particles that have a largest volume distribution value of the second lithium iron phosphate material; and A₁ and A₂ respectively represent a sphericity of the first lithium iron phosphate material and a sphericity of the second lithium iron phosphate material, wherein 0.3≤D¹ₘₒ≤3.2, 1≤D²ₘₒ≤5, and D¹ₘₒ<D²ₘₒ.

2. The lithium iron phosphate positive electrode active material according to claim 1, wherein D¹ₘₒ meets: 0.32≤D¹ₘₒ≤2.45.

3. The lithium iron phosphate positive electrode active material according to claim 1, wherein D¹ₘₒ meets: 0.40≤D¹ₘₒ≤2.45.

4. The lithium iron phosphate positive electrode active material according to claim 1, wherein D²ₘₒ meets: 1.2≤D²ₘₒ≤5.

5. The lithium iron phosphate positive electrode active material according to claim 1, wherein D²ₘₒ meets: 1.25≤D²ₘₒ≤4.95.

6. The lithium iron phosphate positive electrode active material according to claim 1, wherein A₁ meets: 0.5≤A₁<1, and A₂ meets 0.5≤A₂<1.

7. The lithium iron phosphate positive electrode active material according to claim 1, wherein A₁ meets: 0.51≤A₁≤0.95.

8. The lithium iron phosphate positive electrode active material according to claim 1, wherein A₂ meets: 0.51≤A₂≤0.95.

9. The lithium iron phosphate positive electrode active material according to claim 1, wherein the first lithium iron phosphate material meets: 0.5≤0.643D¹ₘₒ+0.439A₁≤2.29.

10. The lithium iron phosphate positive electrode active material according to claim 1, wherein the first lithium iron phosphate material meets: 0.6≤0.643D¹ₘₒ+0.439A₁≤2.29.

11. The lithium iron phosphate positive electrode active material according to claim 1, wherein the second lithium iron phosphate material meets: 0.42≤1.07D²ₘₒ+2.44A₂−1.70D²ₘₒ×A₂≤1.89.

12. The lithium iron phosphate positive electrode active material according to claim 1, wherein a weight ratio of the first lithium iron phosphate material and the second lithium iron phosphate material is in a range of 1:(0.25-3).

13. The lithium iron phosphate positive electrode active material according to claim 1, wherein a weight ratio of the first lithium iron phosphate material and the second lithium iron phosphate material is in a range of 1:(0.25-2.5).

14. The lithium iron phosphate positive electrode active material according to claim 1, wherein a surface of the first lithium iron phosphate material and a surface of the second lithium iron phosphate material are coated with a carbon coating layer.

15. A method for preparing a lithium iron phosphate positive electrode active material, wherein
the lithium iron phosphate positive electrode active material comprises:
a first lithium iron phosphate material and a second lithium iron phosphate material, wherein the first lithium iron phosphate material meets: 0.49<0.643D¹ₘₒ+0.439A₁<2.3, and the second lithium iron phosphate material meets: 0.41<1.07D²ₘₒ+2.44A₂−1.70D²ₘₒ×A₂<1.9, where:
D¹ₘₒ is a particle size of first particles that have a largest volume distribution value of the first lithium iron phosphate material;
D²ₘₒ is a particle size of second particles that have a largest volume distribution value of the second lithium iron phosphate material; and
A₁ and A₂ respectively represent a sphericity of the first lithium iron phosphate material and a sphericity of the second lithium iron phosphate material, wherein 0.3≤D¹ₘₒ≤3.2, 1≤D²ₘₒ≤5, and D¹ₘₒ<D²ₘₒ; and
the method comprises mixing the first lithium iron phosphate material and the second lithium iron phosphate material to obtain the lithium iron phosphate positive electrode active material.

16. A lithium ion battery, comprising a positive electrode sheet, wherein the positive electrode sheet comprises a lithium iron phosphate positive electrode active material, and the lithium iron phosphate positive electrode active material comprises:
a first lithium iron phosphate material and a second lithium iron phosphate material, wherein the first lithium iron phosphate material meets: 0.49<0.643D¹ₘₒ+0.439A₁<2.3, and the second lithium iron phosphate material meets: 0.41<1.07D²ₘₒ+2.44A₂−1.70D²ₘₒ×A₂<1.9, where:
D¹ₘₒ is a particle size of first particles that have a largest volume distribution value of the first lithium iron phosphate material;
D²ₘₒ is a particle size of second particles that have a largest volume distribution value of the second lithium iron phosphate material; and
A₁ and A₂ respectively represent a sphericity of the first lithium iron phosphate material and a sphericity of the second lithium iron phosphate material, wherein 0.3≤D¹ₘₒ≤3.2, 1≤D²ₘₒ≤5, and D¹ₘₒ<D²ₘₒ.

17. The lithium ion battery according to claim 16, further comprising a negative electrode sheet, an electrolyte solution, and a separator located between the positive electrode sheet and the negative electrode sheet.

18. The lithium ion battery according to claim 16, wherein a maximum compaction density of the positive electrode sheet is greater than 2.6 g/cm³.

19. The lithium ion battery according to claim 16, wherein the positive electrode sheet comprises a positive electrode current collector and a positive electrode active material layer disposed on a surface of the positive electrode current collector.

20. The lithium ion battery according to claim 19, wherein the positive electrode active material layer comprises the lithium iron phosphate positive electrode active material, a binder, and a conductive agent.
